(19) United States
(12) Patent Application Publication
(10) Pub. No.: US 2017/0010845 A1
(43) Pub. Date: Jan. 12, 2017

(54) LIGHT CONTROL DEVICE, DISPLAY DEVICE, MULTISCREEN DISPLAY SYSTEM, LIGHT CONTROL METHOD, AND PROGRAM

(71) Applicant: NEC Display Solutions, Ltd., Tokyo (JP)

(72) Inventor: Toshiyuki Noguchi, Tokyo (JP)

(21) Appl. No.: 15/113,769

(22) PCT Filed: Mar. 13, 2014
(86) PCT No.: PCT/JP2014/056615

§ 371 Date: Jul. 22, 2016

(51) Int. Cl. G06F 3/147; G09G 3/34; G06F 3/14

(52) U.S. Cl. CPC G06F 3/147; G06F 3/1446; G09G 3/3426; G09G 2300/026; G09G 2320/0233; G09G 2320/0633; G09G 2330/023

(57) ABSTRACT

A display apparatus in a multiscreen display system includes an enlargement processing unit that converts a video signal of a video source to a video signal of an enlarged video having a size corresponding to a large screen and outputs a video signal of a sectional video in the enlarged video so as to display the sectional video on a liquid crystal panel, where the sectional video is associated with a position on the large screen formed by arranged screens of liquid crystal panels; a video analyzing unit that analyzes the video signal of the video source before this video signal is converted by the enlargement processing unit to the video signal of the enlarged video, so as to obtain predetermined video characteristics about the video signal of the video source; and a light control unit that performs light control of a backlight in accordance with a light control value.

### TECHNICAL FIELD

The present invention relates to a light control device, a display device, a multiscreen display system, a light control method, and a program.

### BACKGROUND ART

A multiscreen display apparatus is known, which forms one display screen by using screens of a plurality of display devices arrayed in the vertical and horizontal directions (see, for example, Patent Document 1).

In addition, for a display device provided with a liquid crystal panel, a known technique called “dimming” is used for power saving or improvement of image quality by controlling a backlight that emits light from the back surface side of the liquid crystal panel, in accordance with a video to be displayed (see, for example, Patent Document 2).

### PRIOR ART DOCUMENT

### Patent Document

### Patent Document 1: Japanese Unexamined Patent Application, First Publication No. 2007-164060.

### Patent Document 2: Japanese Unexamined Patent Application, First Publication No. 2011-232590.

### DISCLOSURE OF INVENTION

### Problem to be Solved by the Invention

Regarding the above-described background art, a multiscreen display apparatus (or a multiscreen display system), which is formed by the display devices (each having a liquid crystal panel), may employ the dimming.

For example, each display device of the multiscreen display system receives a video signal of a video source to be displayed and enlarges a video corresponding to the video signal to have a size applicable to the multiscreen display. Each display device displays a sectional video on its screen, where the sectional video is associated with the position where this display device is arranged for the enlarged video.

The backlight is independently driven in each display device. Accordingly, the dimming is also executed independently by each display device. In this process, the display device executes the dimming according to a sectional video corresponding to the own device. Depending on the content of the video displayed by a multiscreen, parts having high luminance and parts having low luminance may coexist. In such a case, when each of the display devices in the multiscreen display system executes the dimming according to the sectional video corresponding to the own device as described above, variation may occur in the degree of light control between the individual display devices, and the quality of the video displayed on the whole screen as a multiscreen may be degraded. More specifically, although the gradation of luminance for the whole screen should be uniform between the sectional videos as a whole, a variation may occur in the gradation due to a boundary between the display devices.

In light of the above circumstances, for the light control of a backlight for a liquid crystal panel of each display device in a multiscreen display apparatus, an object of the present invention is to prevent degradation in the video displayed on the whole screen as a multiscreen.

### Means for Solving the Problem

A light control device as one mode of the present invention comprises:

an enlargement processing unit that:
converts a video signal of a video source to a video signal of an enlarged video having a size corresponding to a large screen which is formed by arranging screens of a plurality of display devices in accordance with a predetermined arrangement pattern, and
outputs a video signal of a sectional video in the enlarged video so as to display the sectional video on a liquid crystal panel that corresponds to one of the screens, where the sectional video is associated with a position of the relevant screen in the large screen;

a video analyzing unit that analyzes the video signal of the video source before this video signal is converted by the enlargement processing unit to the video signal of the enlarged video, so as to obtain predetermined video characteristics about the video signal of the video source; and

a light control unit that performs light control of a backlight, which emits light to the liquid crystal panel, in accordance with a light control value determined according to the video characteristics analyzed by the video analyzing unit.

A display device as one mode of the present invention comprises:

a liquid crystal panel that corresponds to one of screens of a multiscreen display apparatus that displays one enlarged video on a large screen which is formed by arranging the screens of a plurality of display devices in accordance with a predetermined arrangement pattern;

a backlight that emits light to the liquid crystal panel;

an enlargement processing unit that converts a video signal of a video source to a video signal of the enlarged video having a size corresponding to the large screen and outputs a video signal of a sectional video in the enlarged video so as to display the sectional video on the liquid crystal panel, where the sectional video is associated with a position of the relevant screen in the large screen;

a video analyzing unit that analyzes the video signal of the video source before this video signal is converted by the enlargement processing unit to the video signal of the enlarged video, so as to obtain predetermined video characteristics about the video signal of the video source; and

a light control unit that performs light control of the backlight in accordance with a light control value determined based on the video characteristics analyzed by the video analyzing unit.

A multiscreen display system as one mode of the present invention comprises:

a plurality of display devices that form a large screen, on which one enlarged video is displayed, by arranging screens of the individual display devices in accordance with a predetermined arrangement pattern,

wherein each display device comprises:

a liquid crystal panel that corresponds to one of the screens which form the large screen;

a backlight that emits light to the liquid crystal panel;

an enlargement processing unit that converts a video signal of a video source to a video signal of the enlarged video and outputs a video signal of a sectional video in the enlarged video so as to display the sectional video on the liquid crystal panel, where the sectional video is associated with a position of the relevant screen in the large screen;

a video analyzing unit that analyzes the video signal of the video source before this video signal is converted by the enlargement processing unit to the video signal of the enlarged video, so as to obtain predetermined video characteristics about the video signal of the video source; and

a light control unit that performs light control of the backlight in accordance with a light control value determined based on the video characteristics analyzed by the video analyzing unit.

A light control method as one mode of the present invention comprises:

an enlargement processing step that:
converts a video signal of a video source to a video signal of an enlarged video having a size corresponding to a large screen which is formed by arranging screens of a plurality of display devices in accordance with a predetermined arrangement pattern; and
outputs a video signal of a sectional video in the enlarged video so as to display the sectional video on a liquid crystal panel that corresponds to one of the screens, where the sectional video is associated with a position of the relevant screen in the large screen;

a video analyzing step that analyzes the video signal of the video source before this video signal is converted by the enlargement processing step to the video signal of the enlarged video, so as to obtain predetermined video characteristics about the video signal of the video source; and

a light control step that performs light control of a backlight, which emits light to the liquid crystal panel, in accordance with a light control value determined based on the video characteristics analyzed by the video analyzing step.

A program as one mode of the present invention makes a computer execute:

an enlargement processing step that:
converts a video signal of a video source to a video signal of an enlarged video having a size corresponding to a large screen which is formed by arranging screens of a plurality of display devices in accordance with a predetermined arrangement pattern; and
outputs a video signal of a sectional video in the enlarged video so as to display the sectional video on a liquid crystal panel that corresponds to one of the screens, where the sectional video is associated with a position of the relevant screen in the large screen;

a video analyzing step that analyzes the video signal of the video source before this video signal is converted by the enlargement processing step to the video signal of the enlarged video, so as to obtain predetermined video characteristics about the video signal of the video source; and

a light control step that performs light control of a backlight, which emits light to the liquid crystal panel, in accordance with a light control value determined based on the video characteristics analyzed by the video analyzing step.

### Effect of the Invention

According to the present invention, for the light control of a backlight for a liquid crystal panel of each display device in a multiscreen display apparatus, it is possible to prevent degradation in the video displayed on the whole screen as a multiscreen.

### BRIEF DESCRIPTION OF THE DRAWINGS

FIG. 1 is a diagram showing an example of the arrangement of display devices in a multiscreen display system as an embodiment.

FIG. 2 is a diagram showing an example how a video signal is supplied to each display device in the multiscreen display system in the embodiment.

FIG. 3 is a diagram showing the configuration of a display device in a comparative example.

FIG. 4 is a diagram showing an example of the processing performed by the display device in the comparative example.

FIG. 5 is a diagram showing an example of the content of a video according to a video signal of a source video.

FIG. 6 is a diagram showing an example of average luminance of a sectional video, which is determined for the screen of each of the display apparatuses which form the multiscreen display system in the comparative example.

FIG. 7 is a diagram showing an example of the configuration of the display device in the first embodiment.

FIG. 8 is a diagram showing an example of the processing performed by the display device in the first embodiment.

FIG. 9 is a diagram showing an example of average luminance of a sectional video, which is determined for the screen of each display apparatus in the multiscreen display system of the first embodiment.

FIG. 10 is a diagram showing an example of setting light control areas in a multiscreen display system of a second embodiment.

FIG. 11 is a diagram showing an example of setting the light control value for each light control area when a video of a video source is displayed on the screen of one display apparatus.

FIG. 12 is a diagram showing an example of setting the light control value for each light control area when a video of a video source is displayed on the screen of one display apparatus.

FIG. 13 is a diagram showing an example of setting the light control value for each light control area in the second embodiment.

FIG. 14 is a diagram showing an example of the processing performed by the display device in the second embodiment.

FIG. 15 is a diagram showing an example of the processing performed by the display device in the second embodiment.

FIG. 16 is a diagram showing a minimum configuration of a display device according to the present invention.

### MODE FOR CARRYING OUT THE INVENTION

### First Embodiment

### Example of Configuration of Multiscreen Display System

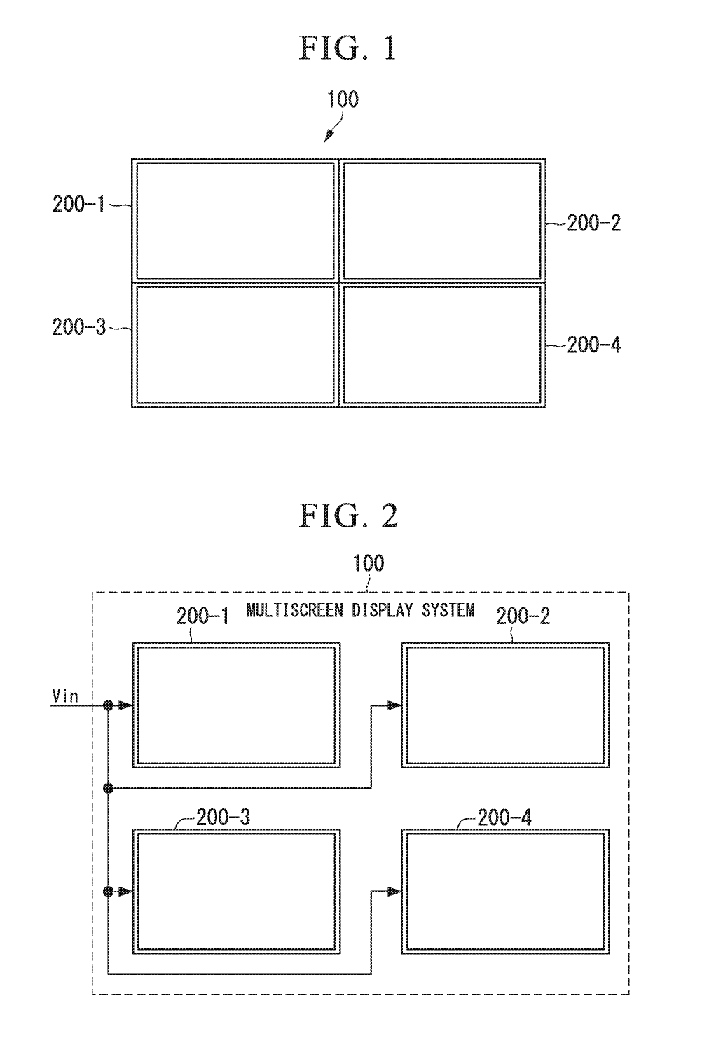

FIG. 1 shows an example of the arrangement of display devices in a multiscreen display system 100 as a first embodiment of the present invention.

The multiscreen display system 100 of the present embodiment may include four display devices 200-1, 200-2, 200-3, and 200-4. In the following explanation, when the display devices 200-1, 200-2, 200-3, and 200-4 are not distinguished with each other particularly, each device is called a “display device 200”.

In the example of FIG. 1, the four display devices 200 are arranged in 2 rows by 2 columns (2 rows×2 columns). In this arrangement, the display device 200-1 is located at a position of the first row and the first column, the display device 200-2 is located at a position of the first row and the second column, the display device 200-3 is located at a position of the second row and the first column, and the display device 200-4 is located at a position of the second row and the second column.

According to the above arrangement of the four display devices 200, one large screen is formed by these display devices 200.

Although FIG. 1 shows the example of arranging the four display devices in 2 rows by 2 columns, the number of the display devices 200 which form the multiscreen display system and an arrangement pattern therefor are not limited. For example, an arrangement pattern other than “M rows×N columns” (M and N are natural numbers) may be employed.

FIG. 2 shows an example how a video signal is supplied to each display device 200 in the multiscreen display system 100 of FIG. 1.

The multiscreen display system 100 receives a video signal Vin of a video source to be displayed in the large screen as the multiscreen. In the multiscreen display system 100, the received video signal Vin is input into each of the display devices 200-1 to 200-4 in a manner such that the signal branches to the individual display devices.

In the multiscreen display system 100 configured as described above, each of the display devices 200 has a liquid crystal panel as display means. In addition, the display device 200 of the present embodiment executes the dimming for power saving, improvement of image quality, or the like. The dimming is a control of light emitted from the backlight to the liquid crystal panel in accordance with the characteristics (e.g., luminance) of a video to be displayed.

### Example of Configuration for Dimming in Multiscreen Display System

Below, a comparative example (an example for reference) in contrast to the present embodiment will be explained, where the dimming is executed by the display devices of a multiscreen display system.

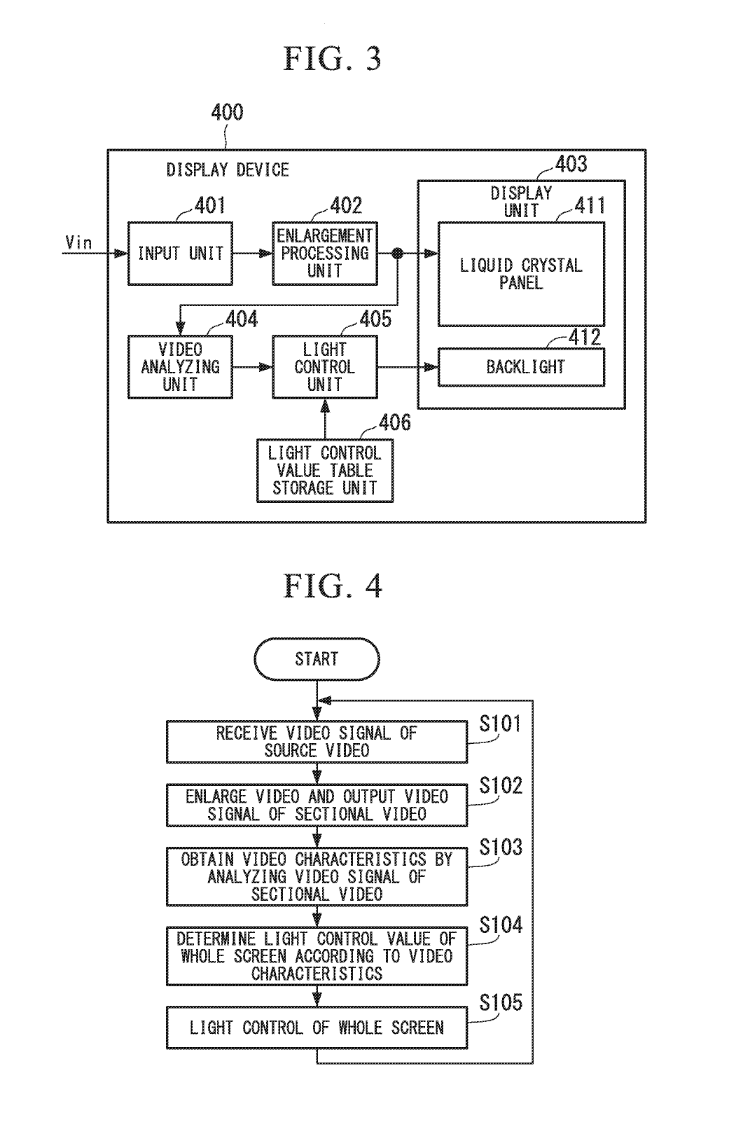

FIG. 3 shows an example of the configuration of a display device 400 in the comparative example. The display device 400 has an input unit 401, an enlargement processing unit 402, a display unit 403, a video analyzing unit 404, a light control unit 405, and a light control value table storage unit 406.

The input unit 401 receives a video signal Vin and outputs it into the enlargement processing unit 402.

The enlargement processing unit 402 generates an enlarged video by enlarging the video of the video signal Vin to have a size corresponding to the large screen formed by a plurality of the display devices 400 in the multiscreen display system. In addition, the enlargement processing unit 402 extracts (from the enlarged video) a sectional video corresponding to a position, at which the present display device 400 is located in the multiscreen display system, and outputs a video signal of the extracted sectional video to the display unit 403.

The display unit 403 displays, as a video, the video signal supplied from the enlargement processing unit 402. The display unit 403 includes a liquid crystal panel 411 and a backlight 412.

The liquid crystal panel 411 drives a liquid crystal element corresponding to each pixel, according to the video signal supplied from the enlargement processing unit 402. In this process, the backlight 412 emits light from the back surface side of the liquid crystal panel 411. Accordingly, in the liquid crystal panel 411, transmitted light emitted from the backlight 412 is modulated in accordance with the video signal so that the sectional video is displayed on the screen of the liquid crystal panel 411.

The video analyzing unit 404 analyzes the video signal of the sectional video output from the enlargement processing unit 402 so as to obtain predetermined video characteristics about this sectional video. As a specific example, the video analyzing unit 404 computes an average luminance of the sectional video as the video characteristics.

According to the video characteristics (average luminance) computed by the video analyzing unit 404, the light control unit 405 determines the light control value assigned to the whole screen of the liquid crystal panel 411.

When the light control value is determined, the light control unit 405 may refer to a light control value table stored in the light control value table storage unit 406. The light control value table may be a table in which light control values are assigned with individual values of the video characteristics (values of average luminance).

In accordance with the light control value as determined above, the light control unit 405 performs light control of the backlight 412.

Accordingly, the strength of light emitted from the backlight 412 toward the whole screen of the liquid crystal panel 411 varies depending on each sectional video.

Such dimming of controlling the light of the backlight 412 uniformly for the whole screen of the liquid crystal panel 411 is called “global dimming”.

The flowchart in FIG. 4 shows an example of the processing for the dimming, which is performed by the display device 400 in FIG. 3.

In the display device 400, the input unit 401 receives a video signal Vin of a source video (see step S101).

Next, the enlargement processing unit 402 enlarges a video of the video signal Vin of the source video to have a size corresponding to the large screen, extracts a sectional video corresponding to the arrangement position of the display device 400 from the enlarged video, and outputs the video signal of the sectional video to the liquid crystal panel 411 (see step S102). Accordingly, the sectional video is displayed on the screen of the liquid crystal panel 411.

The video analyzing unit 404 receives the video signal of the sectional video output from the enlargement processing unit 402 and analyzes the video signal so as to obtain the video characteristics about this sectional video (see step S103).

The light control unit 405 may refer to the light control value table stored in the light control value table storage unit 406 and determines the light control value assigned to the whole screen of the liquid crystal panel 411 according to the video characteristics (average luminance of the sectional video) obtained in step S103 (see step S104).

According to the light control value determined in step S104, the light control unit 405 executes the light control (i.e., dimming) of the backlight 412 in the display unit 403 (see step S105).

In the dimming by the display device 400 as shown in FIGS. 3 and 4, the quality of the video displayed in the large screen of the multiscreen display system may be degraded as explained below.

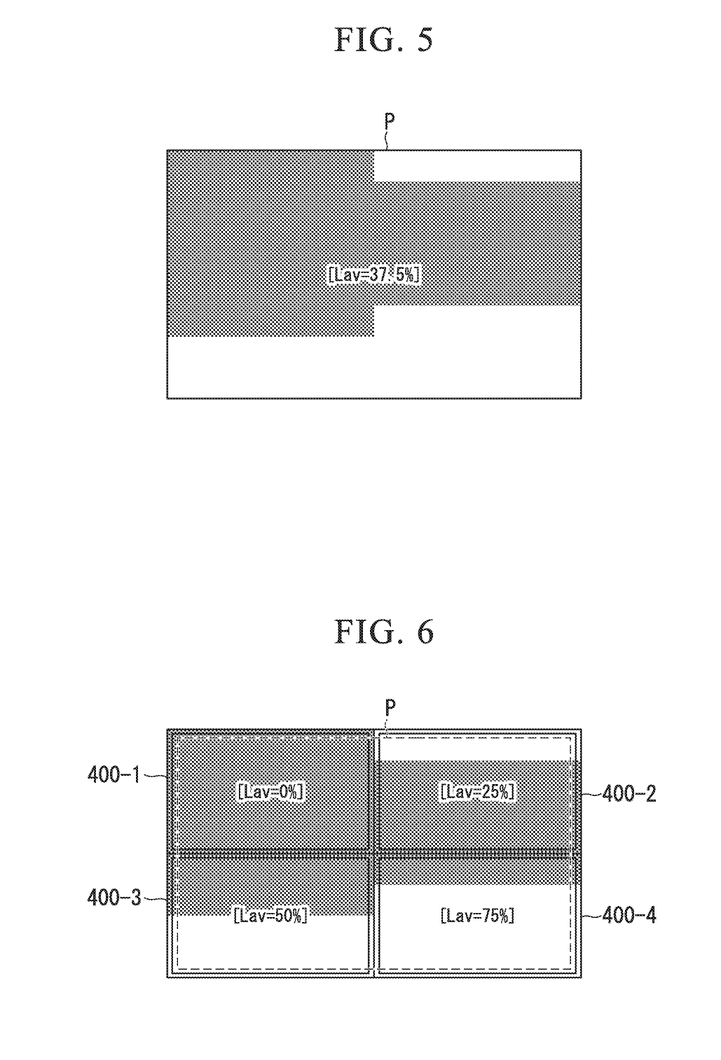

FIG. 5 shows an example of the content of a video P according to the video signal of the source video. The video P includes both white video parts and a black video part in accordance with a pattern shown in FIG. 5.

For example, an average luminance Lay obtained by analyzing the video signal of video P (shown in FIG. 5) by performing the same operation executed by the video analyzing unit 404 is 37.5%. When the video P is displayed, the global dimming is performed according to the light control value determined for the average luminance 37.5%, so that optimization of power consumption, video quality, or the like, is appropriately performed.

FIG. 6 shows a configuration of a multiscreen display system formed by arranging four display devices 400 (400-1 to 400-4) in 2 rows by 2 columns, where the video P of FIG. 5 is shown in the large screen of this system.

In this case, the sectional video of the video P, which is displayed on the screen of the display device 400-1 has a color of black over the whole screen. Accordingly, the average luminance Lay as the video characteristics, which is computed by the video analyzing unit 404 of the display device 400-1, is 0%.

In addition, the sectional video of the video P, which is displayed on the screen of the display device 400-2 has a color of while in the upper ¼ of the whole screen and a color of black in the remaining lower ¾ of the whole screen. Accordingly, the average luminance Lay as the video characteristics, which is computed by the video analyzing unit 404 of the display device 400-2, is 25%.

Additionally, the sectional video of the video P, which is displayed on the screen of the display device 400-3 has a color of black in the upper half of the whole screen and a color of while in the remaining lower half of the whole screen. Accordingly, the average luminance Lay as the video characteristics, which is computed by the video analyzing unit 404 of the display device 400-3, is 50%.

Furthermore, the sectional video of the video P, which is displayed on the screen of the display device 400-4 has a color of black in the upper ¼ of the whole screen and a color of white in the remaining lower ¾ of the whole screen. Accordingly, the average luminance Lay as the video characteristics, which is computed by the video analyzing unit 404 of the display device 400-4, is 75%.

As described above, each display device 400 analyses the sectional video as a target. Therefore, although the average luminance Lay of the original video P is 37.5%, the average luminance Lay computed by each display device 400 is not 37.5% and the individual average luminance values differ from each other.

Since the light control unit 405 determines the light control value according to the video characteristics as the average luminance Lay as computed above, the light control value is also different between the display devices 400.

Therefore, when the video P is displayed on the large screen as shown in FIG. 6, the following state occurs.

That is, in the display device 400-1, according to the average luminance Lay of 0% for the sectional video, the minimum light control value may be selected to emphasize the level of black. Accordingly, light from the backlight 412 of the display device 400-1 is controlled so that the light strength thereof is minimized.

In contrast, in the display device 400-2, according to the average luminance Lay of 25% for the sectional video, a light control value greater than that selected in the display device 400-1 is selected. Accordingly, light from the backlight 412 of the display device 400-2 is controlled so that the light strength thereof is higher in comparison with the display device 400-1.

Similarly, in the display device 400-3, according to the average luminance Lay of 50% for the sectional video, it is determined that the strength of light from the backlight 412 is higher in comparison with the display devices 400-1 and 400-2.

In addition, in the display device 400-4, according to the average luminance Lay of 75% for the sectional video, it is determined that the strength of light from the backlight 412 is further higher in comparison with the display devices 400-1 to 400-3.

Accordingly, for example, although the black regions of the video P to be displayed in the individual display devices 400-1 to 400-4 should be originally displayed with the same level of gradation, the display devices 400-1 to 400-4 have different levels. More specifically, for the black region in the video P, the black region on the display device 400-1 has the lowest level of gradation, and the level of gradation gradually increases in order of the display devices 400-2, 400-3, and 400-4.

The white region of the video P has a similar state. The level of gradation gradually increases in order of the display devices 400-1, 400-2, 400-3, and 400-4.

As described above, according to the dimming by the display device 400, when a video of a video source is displayed on the large screen, if a region which should be displayed with the same level of gradation is present over the screens of a plurality of the display devices 400, a difference in the level of gradation occurs between the screens. That is, according to the dimming by the display device 400, degradation in the video quality occurs such that although a region should be displayed with the same level of gradation on the large screen, the individual screens have different levels of gradation.

As explained below, in the multiscreen display system 100 of the present embodiment, difference in the video state (e.g., level of gradation) produced between the screens of the display devices 200 due to the dimming executed by each of the display devices 200 is cancelled and degradation in the video displayed on the large screen is prevented.

### Example of Configuration of Display Device in Present Embodiment

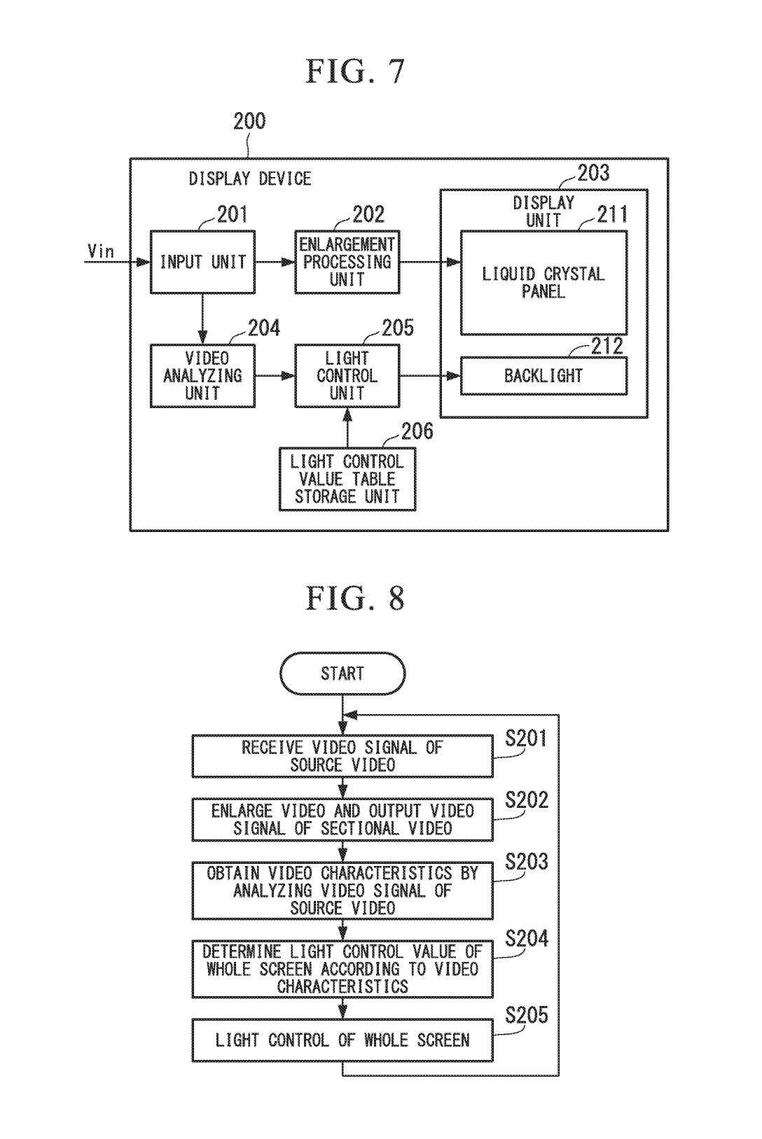

FIG. 7 shows an example of the configuration of the display device 200 in the present embodiment. The display device 200 has an input unit 201, an enlargement processing unit 202, a display unit 203, a video analyzing unit 204, a light control unit 205, and a light control value table storage unit 206.

The input unit 201 receives a video signal Vin of a video source to be displayed on the large screen of the multiscreen display system 100 and outputs the signal into the enlargement processing unit 202.

The enlargement processing unit 202 converts the video signal of the video source to a video signal of an enlarged video having a size corresponding to the large screen. In addition, the enlargement processing unit 202 outputs a video signal of a sectional video (in the enlarged video) corresponding to the position of the present screen on the large screen, so as to display the sectional video on a liquid crystal panel 211.

That is, the enlargement processing unit 202 generates the enlarged video by enlarging the video of the video signal Vin in accordance with the size corresponding to the large screen. Specifically, according to an enlargement ratio between the resolution of the video signal of the video source and the resolution of the large screen, the enlargement processing unit 202 may perform a video enlarging operation accompanied with a pixel interpolation process or the like.

The enlargement processing unit 202 extracts (from the enlarged video) a sectional video corresponding to a position, at which the screen of the present display device 200 is located in the large screen of the multiscreen display system, and outputs a video signal of the extracted sectional video to the liquid crystal panel 211 of the display unit 203.

The display unit 203 displays, as a video, the video signal supplied from the enlargement processing unit 202. The display unit 203 includes the liquid crystal panel 211 and a backlight 212.

The liquid crystal panel 211 is a transmission type and drives the liquid crystal corresponding to each pixel, according to the video signal supplied from the enlargement processing unit 202. In this process, the backlight 212 emits light from the back surface side of the liquid crystal panel 211.

Accordingly, in the liquid crystal panel 211, light which is emitted from the backlight 212 from the back surface side of the panel and transmitted toward the front surface side of the panel, is modulated in accordance with the video signal of the sectional video. Accordingly, the sectional video is displayed on the screen of the liquid crystal panel 411.

The backlight 212 may be formed by utilizing LEDs (light emitted diodes). Light of the LED can be easily controlled and thus is suitable for dimming.

The video analyzing unit 204 in FIG. 3 analyzes the video signal of the sectional video, which is output from the enlargement processing unit 402.

In contrast, the video analyzing unit 204 of the present embodiment receives the video signal Vin of the video source input into the input unit 201 and analyzes the video signal Vin to obtain predetermined video characteristics about the video signal Vin of the video source.

That is, the video analyzing unit 204 analyzes the video signal of the video source before this video signal is converted by the enlargement processing unit 202 to the video signal of the enlarged video, so that the video analyzing unit 204 obtains predetermined video characteristics about the video signal Vin of the video source.

As an example, the video characteristics analyzed and computed by the video analyzing unit 204 is an average luminance. The video analyzing unit 204 of the first embodiment may compute an average luminance Lay for the entire video P as shown in FIG. 5.

The light control unit 205 performs the light control of the backlight 212 in accordance with a light control value determined according to the video characteristics analyzed by the video analyzing unit 204. According to the video characteristics (average luminance Lay) computed by the video analyzing unit 204, the light control unit 205 of the first embodiment determines the light control value assigned to the whole screen of the liquid crystal panel 211.

When the light control value is determined, the light control unit 205 may refer to a light control value table stored in the light control value table storage unit 206. The light control value table may be a table in which light control values are assigned with individual values which can be average luminance as the video characteristics. The light control unit 205 retrieves a light control value, which is assigned to the average luminance Lay (i.e., video characteristics obtained by video analyzing unit 204), from the light control value table and determines the retrieved light control value to be the result of the relevant determination.

According to the light control value as determined above, the light control unit 205 executes the light control in a manner such that the strength of light emitted from the backlight 212 to the entire liquid crystal panel 411 is uniformly changed. That is, in the first embodiment, the light control as global dimming is performed. Accordingly, the strength of light emitted from the backlight 212 toward the whole screen of the liquid crystal panel 211 varies depending on each sectional video.

### Example of the Processing

The flowchart in FIG. 8 shows an example of the processing for the dimming, which is performed by the display device 200 in FIG. 7 in the first embodiment.

In the display device 200, the input unit 201 receives a video signal Vin of a source video (see step S201).

Next, the enlargement processing unit 202 enlarges a video of the video signal Vin of the source video to have a size corresponding to the large screen and extracts a sectional video corresponding to the arrangement position of the display device 200 from the enlarged video. Then the enlargement processing unit 202 outputs the video signal of the sectional video to the liquid crystal panel 211 (see step S202). Accordingly, the sectional video is displayed on the screen of the liquid crystal panel 211.

The video analyzing unit 204 receives the video signal Vin of the video source input into the input unit 201 and analyzes the signal, so that the video analyzing unit 204 obtains the video characteristics about the video of the video source (i.e., average luminance of the entire enlarged video) (see step S203).

As described above, the light control unit 205 may refer to the light control value table stored in the light control value table storage unit 206 and determines the light control value according to the video characteristics (average luminance Lay) obtained in step S203 (see step S204).

In comparison with the light control value which is determined by the light control unit 405 in FIG. 3 and corresponds to the sectional video, the light control value determined by the light control unit 205 is according to the video characteristics (average luminance Lay) of the entire enlarged video. Therefore, the determined light control value corresponds to the entire enlarged video.

According to the light control value determined in step S204, the light control unit 205 uniformly changes the strength of light emitted from the backlight 212 to the entire screen of the liquid crystal panel 211 (see step S205). Accordingly, the light control unit 205 executes the light control as the global dimming.

### Example of the Results of Video Display in the First Embodiment

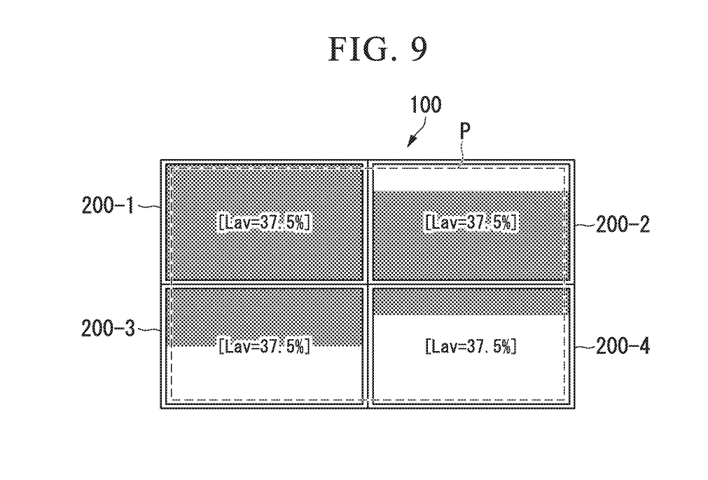

FIG. 9 shows a state in which a video P similar to that shown in FIG. 5 is displayed in the relevant large screen by the multiscreen display system 100 of the first embodiment.

The video analyzing unit 204 in each of the display devices 200-1 to 200-4 obtains, not the video characteristics for a sectional video of the video P, but the video characteristics for the entire video P. Therefore, the video characteristic values obtained by the individual display devices 200-1 to 200-4 are each 37.5%, that is, the average luminance Lay for the entire video P shown in FIG. 5.

According to this setting, the light control unit 205 in each of the display devices 200-1 to 200-4 sets the same light control value corresponding to the average luminance of 37.5% and executes the global dimming according to this light control value.

Accordingly, the light strength of the backlight 212 of each screen of the display devices 200-1 to 200-4 is uniform. Therefore, for example, the level of gradation of the black region (in the video P) which spreads over the screens of the display devices 200-1 to 200-4 is the same. Similarly, the level of gradation of the white region displayed on the screens of the display devices 200-2, 200-3, and 200-4 is the same between these screens. Therefore, in the entire large screen formed by the display devices 200-1 to 200-4, the black and white regions in the video P each have the same level of gradation. In addition, since the light control value assigned to each screen in the large screen is according to the average luminance of 37.5%, the light control value suits the video P.

Accordingly, in the present embodiment, difference in the video state (as the gradation) between the display devices 200-1 to 200-4 can be cancelled. Therefore, degradation in the quality of the video displayed on the large screen is prevented.

### Second Embodiment

Next, the second embodiment will be explained.

In the second embodiment, each display device 200 in the multiscreen display system 100 executes the light control as local dimming of the backlight 212.

In the local dimming, the screen of the display device is divided into a plurality of light control areas, and the strength of light emitted from the backlight 212 is individually controlled for each divided light control area.

Here, the configuration of the multiscreen display system 100 in the second embodiment is similar to that shown in FIGS. 1 and 2.

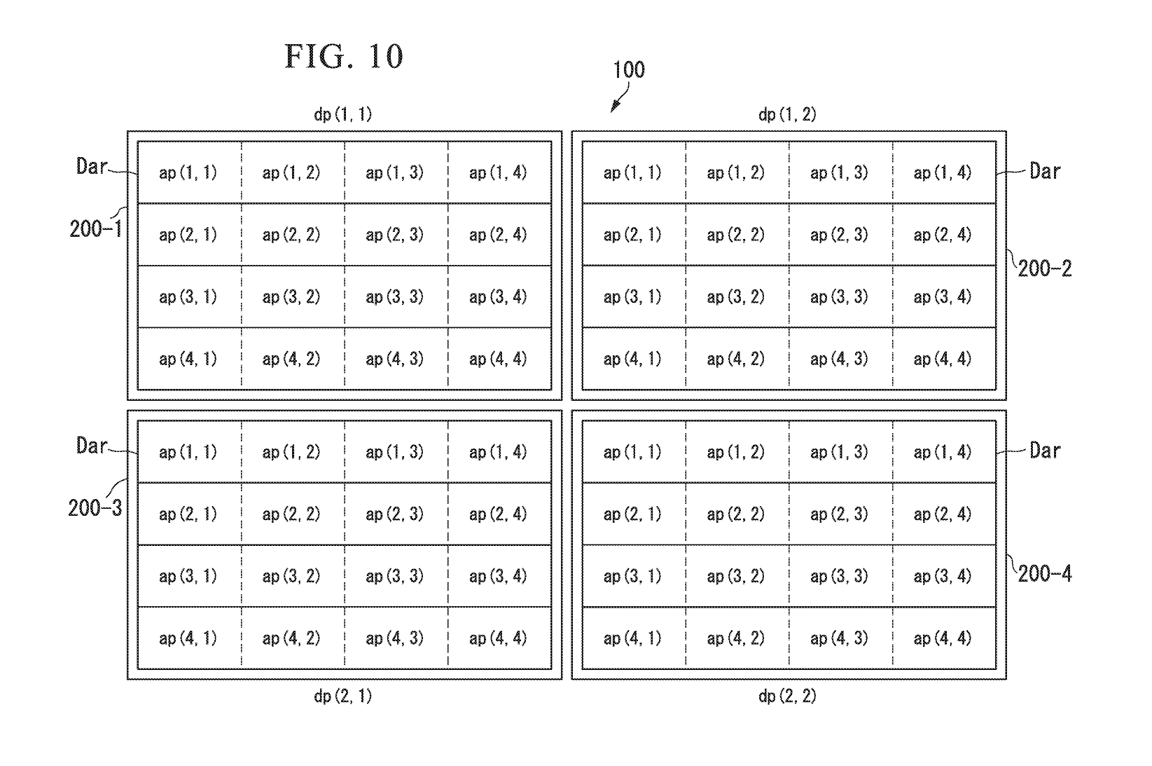

FIG. 10 shows an example of light control areas “Dar” set in each of the display devices 200 in the multiscreen display system 100 of the second embodiment. In the example of FIG. 10, the screen of one display device 200 is divided into 16 light control areas Dar in a form of 4 rows×4 columns.

In addition, the position of the screen of the relevant display device 200 in the large screen of the multiscreen display system 100 is indicated by a screen position “dp (row number, column number)”. Additionally, the position of each light control area Dar in one display device 200 is indicated by a light control area position “ap (row number, column number)”. Therefore, the position of each light control area Dar in the large screen is indicated by a combination of the screen position dp (row number, column number) and the light control area position ap (row number, column number). For example, a combination of “screen position dp (1, 2) and light control area position ap (2, 3)” indicates the light control area Dar positioned in the second row and the third column of the display device 200-2.

Example of the Light Control Value Setting in the Local Dimming when a Video Source is Displayed on the Screen of One Display Device

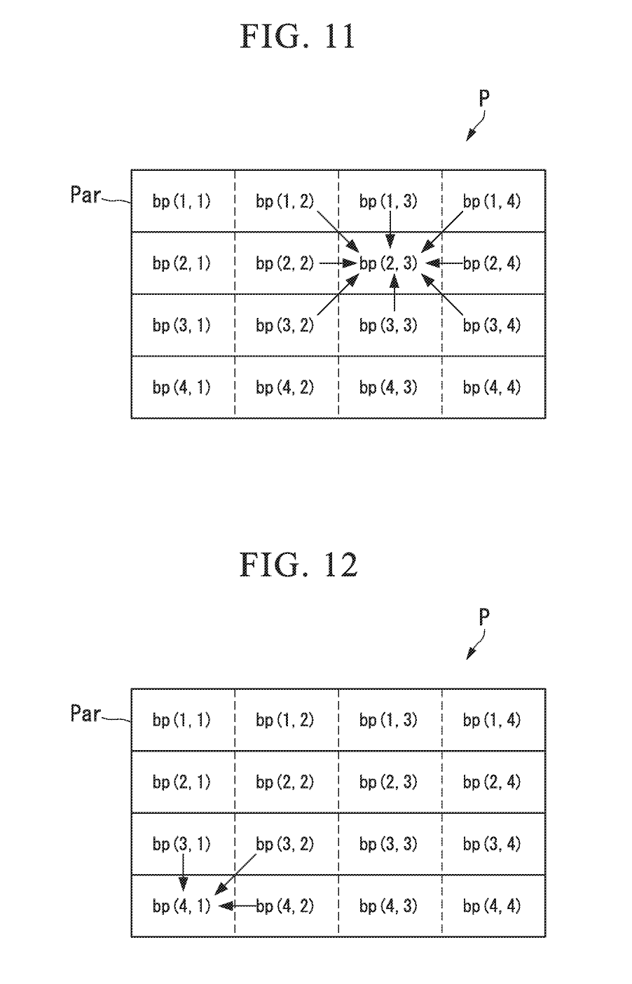

In comparison with the second embodiment, FIGS. 11 and 12 show an example of the light control value setting in the local dimming when a video of a video source is displayed on the screen of one display device. In the explanation of FIGS. 11 and 12, the screen of the display device is divided into 16 light control areas Dar in a form of 4 rows×4 columns similar to the display device 200 shown in FIG. 10.

In the local dimming, first, the video P of the video source is divided into video areas “Par” corresponding to the light control areas Dar. For example, in FIGS. 11 and 12, the position of each video area Par of the video P is indicated by a video area position “bp (row number, column number)”. The row number and the column number of each video area position by are the same as the row number and the column number of the corresponding light control area Dar. For example, the video area Par at the video area position by (2, 3) corresponds to the light control area Dar at the light control area position ap (2, 3).

FIG. 11 schematically shows an operation of setting the light control value of the video area Par at the video area position by (2, 3). In order to set the light control value of the video area Par, the display device obtains, in advance, the video characteristics of each video area Par of the video P by analyzing each video area Par.

When the light control value of the video area Par at the video area position by (2, 3) shown in FIG. 11 is set, the display device utilizes, in addition to the video characteristics of the video area Par at the video area position by (2, 3), the video characteristics of the video areas indicated by arrows in FIG. 11. That is, the display device also utilizes the video characteristics of eight video areas Par at the positions which are adjacent to the video area position by (2, 3) in the vertical and horizontal directions and also in oblique directions.

FIG. 12 schematically shows an operation of setting the light control value of the video area Par at the video area position by (4, 1) among the video areas Par set on the video P in a manner similar to that of FIG. 11.

The video area Par at the video area position by (4, 1) is located at the lower-left corner among the video areas Par set in the video P. Therefore, in the video P, no video area Par is present at each position on the left and lower sides of the video area Par at the video area position by (4, 1).

In this case, the display device obtains, in addition to the video characteristics of the video area Par at the video area position by (4, 1), the video characteristics of three video areas Par which are positioned on the upper, upper-right, and left of the video area Par at the video area position by (4, 1). Then the display device determines the light control value for the video area Par at the video area position by (4, 1) by utilizing these video characteristics.

### Example of the Light Control Value Setting in the Second Embodiment

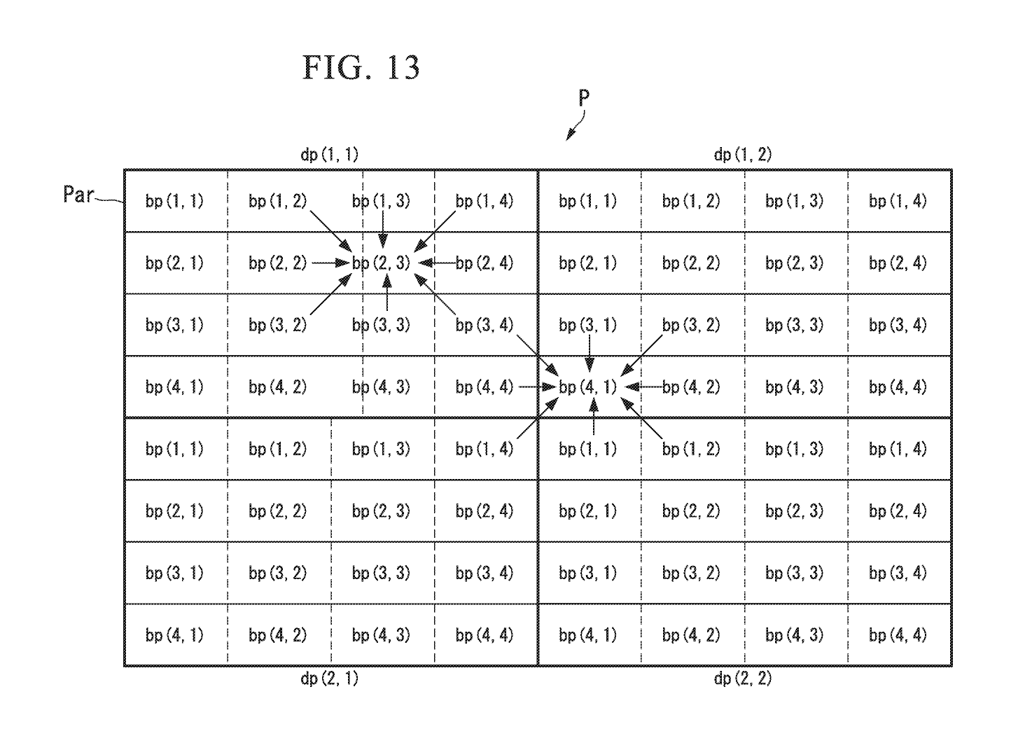

Next, with reference to FIG. 13, an example of setting the light control value for each video area Par in the second embodiment will be explained.

The configuration of the display device 200 in the second embodiment is similar to that shown in FIG. 7. However, the backlight 212 has a structure by which each of the light control areas Dar, which are defined as shown in FIG. 10, can be independently controlled. As an example, such a backlight can be configured as explained below. That is, on the back surface side of the liquid crystal panel 211, LEDs as backlight elements are arranged in a predetermined arrangement pattern. In the relevant configuration, the light strength of the LED which irradiates each light control area Dar can be changed independently.

According to the above configuration, the video analyzing unit 204 of the display device 200 in the second embodiment analyzes each video area Par in the video P and obtains the video characteristics of each video area Par in the video P. In the second embodiment, the video characteristics may also be the average luminance Lay obtained for each video area Par.

In addition, the light control unit 205 controls the backlight 212 to perform the light control of each light control area Dar.

FIG. 13 shows video areas Par which are arranged in the relevant sectional video by each display device 200 in the multiscreen display system 100, in accordance with the setting of the light control areas Dar (see FIG. 10) for the relevant display device 200.

In FIG. 13, the position of each video area Par is indicated by a combination of the screen position “dp (row number, column number)”, which indicates the position of the screen of the display device 200 in the large screen, and a video area position “bp (row number, column number)” of this display device. For example, the position of the video area Par corresponding to the light control area Dar at the light control area position ap (2, 3) of the display device 200-1 shown in FIG. 10 can be indicated by “screen position dp (1, 1) and video area position by (2, 3)”.

For example, the light control unit 205 sets the light control value of the light control area Dar corresponding to the video area Par defined by “screen position dp (1, 1) and video area position by (2, 3)” in FIG. 13, as explained below.

That is, for the video area Par of “screen position dp (1, 1) and video area position by (2, 3)”, the light control unit 205 sets the light control value by utilizing the video characteristics of the own area and the video characteristics of other video areas Par adjacent to the own area. As shown by arrows in FIG. 13, the other video areas Par belong to the sectional video corresponding to the same display device 200-1 and are eight video areas Par at the positions which are adjacent to the video area Par of “screen position dp (1, 1) and video area position by (2, 3)”.

Specifically, the light control unit 205 may correct the video characteristics (here, average luminance) of the video area Par of “screen position dp (1, 1) and video area position by (2, 3)” by utilizing the video characteristics (average luminance) of the other video areas Par adjacent to the relevant video area. The video characteristics (average luminance) corrected as shown above are determined by considering the luminance of peripheral video areas Par and thus may have a value to suppress an excessive change in the luminance between adjacent video areas Par. The light control unit 205 then retrieves a light control value, which is assigned to the corrected value of the video characteristics (average luminance), from the light control value table. The light control unit 205 determines the retrieved light control value to be a light control value of the light control area Dar corresponding to the video area Par of “screen position dp (1, 1) and video area position by (2, 3)”.

In addition, a video area Par of “screen position dp (1, 2) and video area position by (4, 1)” is located at the lower-left corner in the sectional video corresponding to the display device 200-3. However, this video area Par of “screen position dp (1, 2) and video area position by (4, 1)” is located at approximately middle of the video P.

The video analyzing unit 204 of each display device 200 in the second embodiment receives a video signal Vin of a video source. Then the video analyzing unit 204 divides the video P of the video signal Vin into 64 video areas Par as shown in FIG. 13 and obtains the video characteristics of each of these video areas Par.

For the video area Par of “screen position dp (1, 2) and video area position by (4, 1)”, the light control unit 205 determines the light control value by utilizing the video characteristics of eight video areas Par (in the video P) which surround the relevant video area.

As described above, when the local dimming is performed in the second embodiment, among the video areas Par located at the corners of each sectional video, the light control value of each video area located (in the video P) adjacently to a sectional video other than the sectional video to which this video area belongs can be determined by utilizing the video characteristics of the adjacent video area Par in the other sectional video.

Accordingly, even in the local dimming, no variation occurs in the video state (e.g., level of gradation) between parts of the relevant video which are present at a boundary of the screens (i.e., sectional videos), where such parts should have the same video state. Therefore, degradation of the image quality is prevented.

In the above example, the video areas Par adjacent to one video area Par corresponding to the target light control area Dar for the light control value setting are defined as “other video areas”. However, as an example, in addition to the video areas Par adjacent to the above one video area Par, “other video areas” may include video areas Par which are further adjacent to the outer periphery of the above adjacent video areas. That is, video areas Par which surround one video area Par and are present in a predetermined range may be defined as “other video areas”.

### Example of the Processing

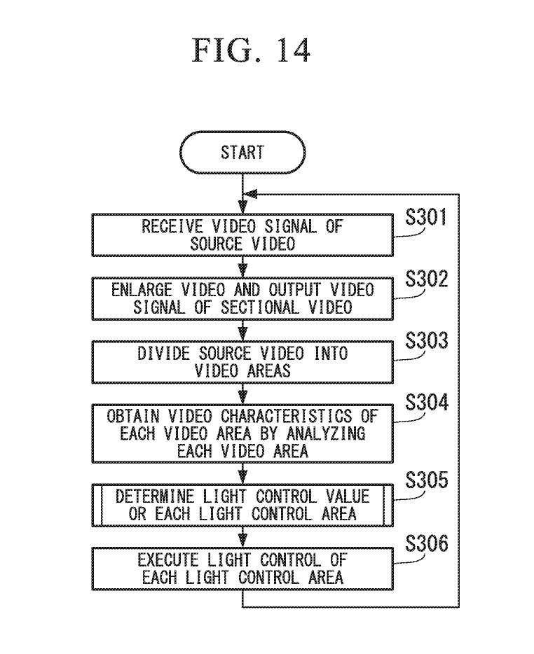

The flowchart in FIG. 14 shows an example of the processing pertaining to the dimming, which is performed by the display device 200 in the second embodiment.

In the display device 200, the input unit 201 receives a video signal Vin of a source video (see step S301).

The enlargement processing unit 202 enlarges a video of the video signal Vin of the source video to have a size corresponding to the large screen, extracts a sectional video corresponding to the arrangement position of the display device 200 from the enlarged video, and outputs the extracted video to the liquid crystal panel 211 (see step S302). Accordingly, the sectional video is displayed on the screen of the liquid crystal panel 211.

The video analyzing unit 204 receives the video signal Vin of the video source, which was input into the input unit 201. As shown in FIG. 13 as an example, the video analyzing unit 204 divides the video P of this video signal Vin into the video areas Par corresponding to the light control areas Dar set for the relevant display device 200 (see step S303).

For this process, the video analyzing unit 204 may divide an extracted part of the video P into the video areas Par, the part including the sectional video assigned to the own device and only video parts (in the other sectional videos) within a range utilized to set the light control value. Accordingly, for example, in comparison with the division of the whole region of the video P into the video areas Par, load on the video signal processing is reduced.

The video analyzing unit 204 performs the analysis of each video area Par divided in step S303 so as to obtain the video characteristics of each video area Par (see step S304).

The light control unit 205 utilizes the video characteristics of each video area Par (obtained in step S304) to determine the light control value for each light control area Dar on the screen of the liquid crystal panel 211 (see step S305). In this process, as explained with reference to FIG. 13, the light control unit 205 utilizes, in addition to the video characteristics of the video areas Par corresponding to the light control area Dar as the target of the light control value setting, the video characteristics of other video areas Par included in a defined range (of the video P) around the video area Par corresponding to the light control area Dar as the light control value setting target.

In accordance with the light control value for each light control area Dar set in step S305, the light control unit 205 executes the light control as the global dimming by which the light strength of each light control area Dar is changed independently (see step S306).

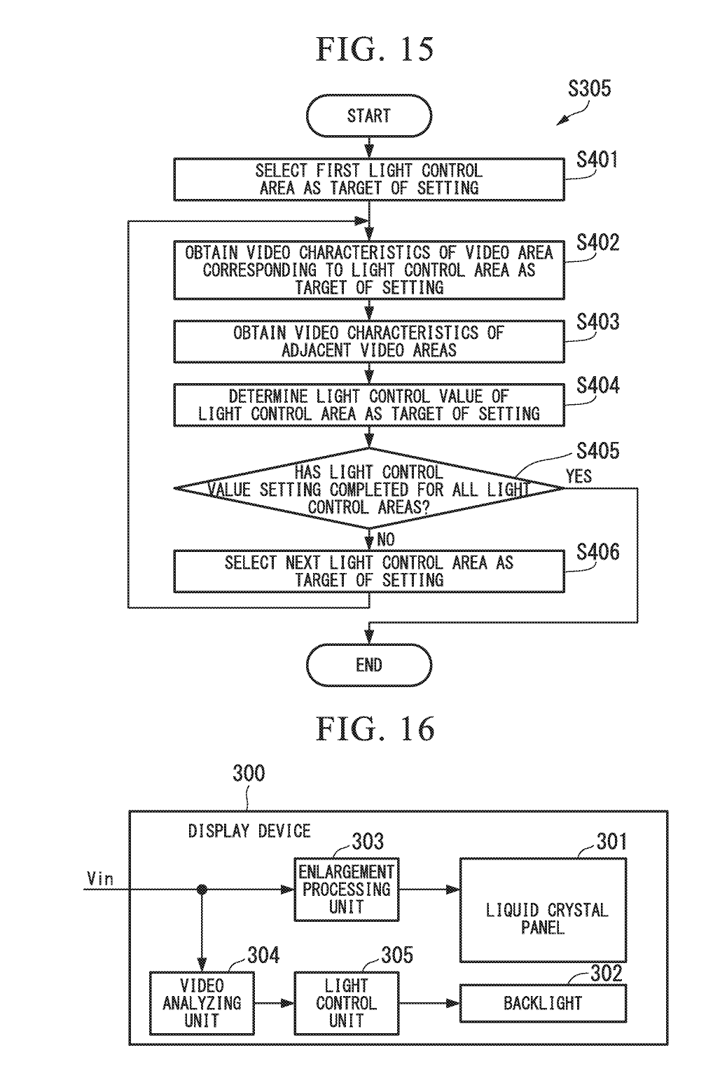

The flowchart in FIG. 15 shows an example of the processing performed by the light control unit 205 so as to set the light control value in step S305 of FIG. 14.

The light control unit 205 selects, for example, the first light control area as the target of the light control value setting among the light control areas Dar set on the display unit 203 (see step S401).

Next, among the video characteristics of the individual video areas Par obtained by the video analyzing unit 204, the light control unit 205 obtains the video characteristics of the video area Par corresponding to the light control area Dar as the target of the light control value setting (see step S402).

Again among the video characteristics of the individual video areas Par obtained by the video analyzing unit 204, the light control unit 205 obtains the video characteristics of video area(s) Par (in the video P) adjacent to the video area Par corresponding to the light control area Dar as the target of the light control value setting (see step S403).

The light control unit 205 utilizes the video characteristics obtained through the steps S402 and S403 to determine the light control value of the target light control area Dar for the light control value setting (see step S404).

The light control unit 205 determines whether or not the light control value setting has completed for all light control areas Dar arranged on the display unit 203 (see step S405).

If there remains a light control area Dar whose light control value has not yet been determined (i.e., “NO” in step S205), the light control unit 205 selects the next light control area Dar as the target of the light control setting (see step S406), and the operation returns to step S402. Accordingly, a process to set the light control value for the next light control area Dar is executed.

When the light control values of all light control areas Dar have been set (i.e., “YES” in step S405), the light control unit 205 terminates the processing shown in FIG. 15.

### Minimum Configuration of Present Invention

FIG. 16 shows a minimum configuration of a display device 300 according to the present invention. The display device 300 in FIG. 16 includes a liquid crystal panel 301, a backlight 302, an enlargement processing unit 303, a video analyzing unit 304, and a light control unit 305.

The liquid crystal panel 301 corresponds to one of the screens of a multiscreen display apparatus which displays one video on a large screen formed by arranging the screens of a plurality of display devices 300 in accordance with a predetermined arrangement pattern.

The backlight 302 emits light to the liquid crystal panel.

The enlargement processing unit 303 converts a video signal Vin of a video source to a video signal of an enlarged video having a size corresponding to the large screen and outputs a video signal of a sectional video (in the enlarged video) corresponding to the relevant position on the large screen formed by arranging the screens of the liquid crystal panels 301, so as to display the sectional video on the liquid crystal panel 301.

The video analyzing unit 304 analyzes the video signal of the video source before this video signal is converted by the enlargement processing unit 303 to the video signal of the enlarged video, so that the video analyzing unit 303 obtains predetermined video characteristics about the video signal of the video source.

The light control unit 305 performs the light control of the backlight 302 in accordance with a light control value determined according to the video characteristics analyzed by the video analyzing unit.

According to the display device 300 shown in FIG. 16, in a multiscreen display apparatus formed by arranging the screens of the plurality of display devices 300, when the light control of the backlight 302 is executed by each display device 300, it is possible to prevent a video, which is displayed on the entire screen formed as a multiscreen, from being degraded.

Instead of the average luminance, the video analyzing unit 204 may obtain a luminance histogram as the video characteristics. In addition, the video characteristics may include information about, not only the luminance, but also the color.

A program used to implement the function of each functional unit in the display device 200 or 300 (shown in FIG. 7 or 16) may be stored in a computer readable storage medium, and the program stored in the storage medium may be loaded and executed on a computer system, so as to execute the relevant control. Here, the computer system includes hardware resources such as an OS, peripheral devices, and the like.

If the computer system employs a WWW system, the computer system can provide a homepage service (or viewable) environment.

The above computer readable storage medium is a storage device, for example, a portable medium such as a flexible disk, a magneto optical disk, a ROM, or a CD-ROM, or a hard disk built in a computer system. The computer readable storage medium also includes a device for temporarily storing the program, such as a volatile memory (RAM) in a computer system which functions as a server or client when the program is transmitted via a network such as the Internet or a communication line such as a telephone line. In addition, the program may execute a part of the above-explained function. In addition, the program may also be a program by which the above-described function can be executed by a combination program of the relevant program and an existing program which has already been stored in the computer system.

While embodiments of the present invention have been described with reference to the drawings, specific structures are not limited to the embodiments. Modifications in design can be made without departing from the scope of the present invention.

### Reference Symbols

100 multiscreen display system
200 display device
201 input unit
202 enlargement processing unit
203 display unit
204 video analyzing unit
205 light control unit
206 light control value table storage unit
211 liquid crystal panel
212 backlight

1. A light control device comprising:
an enlargement processing unit that:
converts a video signal of a video source to a video signal of an enlarged video having a size corresponding to a large screen which is formed by arranging screens of a plurality of display devices in accordance with a predetermined arrangement pattern, and
outputs a video signal of a sectional video in the enlarged video so as to display the sectional video on a liquid crystal panel that corresponds to one of the screens, where the sectional video is associated with a position of the relevant screen in the large screen;
a video analyzing unit that analyzes the video signal of the video source before this video signal is converted by the enlargement processing unit to the video signal of the enlarged video, so as to obtain predetermined video characteristics about the video signal of the video source; and
a light control unit that performs light control of a backlight, which emits light to the liquid crystal panel, in accordance with a light control value determined according to the video characteristics analyzed by the video analyzing unit.

2. The light control device in accordance with claim 1, wherein:
a plurality of light control areas are set on each screen in the large screen and each light control area corresponds to a video area, where the video analyzing unit obtains the video characteristics of each video area by analyzing the video signal of the video source for each video area as a unit for the analysis; and
the light control unit sets a light control value for the light control area as a target of light control value setting by utilizing the video characteristics of the video area corresponding to the light control area as the target of the light control value setting and the video characteristics of other video areas which surround the light control area as the target and are present within a predetermined range, where the light control unit controls the backlight so that light control of each light control area is individually performed according to the light control value.

3. A display device comprising:
a liquid crystal panel that corresponds to one of screens of a multiscreen display apparatus that displays one enlarged video on a large screen which is formed by arranging the screens of a plurality of display devices in accordance with a predetermined arrangement pattern;
a backlight that emits light to the liquid crystal panel;
an enlargement processing unit that converts a video signal of a video source to a video signal of the enlarged video having a size corresponding to the large screen and outputs a video signal of a sectional video in the enlarged video so as to display the sectional video on the liquid crystal panel, where the sectional video is associated with a position of the relevant screen in the large screen;
a video analyzing unit that analyzes the video signal of the video source before this video signal is converted by the enlargement processing unit to the video signal of the enlarged video, so as to obtain predetermined video characteristics about the video signal of the video source; and
a light control unit that performs light control of the backlight in accordance with a light control value determined according to the video characteristics analyzed by the video analyzing unit.

4. (canceled)

5. A light control method comprising:
an enlargement processing that:
converts a video signal of a video source to a video signal of an enlarged video having a size corresponding to a large screen which is formed by arranging screens of a plurality of display devices in accordance with a predetermined arrangement pattern, and
outputs a video signal of a sectional video in the enlarged video so as to display the sectional video on a liquid crystal panel that corresponds to one of the screens, where the sectional video is associated with a position of the relevant screen in the large screen;
a video analyzing that analyzes the video signal of the video source before this video signal is converted by the enlargement processing to the video signal of the enlarged video, so as to obtain predetermined video characteristics about the video signal of the video source; and
a light control that performs light control of a backlight, which emits light to the liquid crystal panel, in accordance with a light control value determined according to the video characteristics analyzed by the video analyzing.

6. (canceled)
